(19) United States
(12) Patent Application Publication
(10) Pub. No.: US 2026/0032737 A1
(43) Pub. Date: Jan. 29, 2026

(54) USER EQUIPMENT (UE) INITIATED GRANT REQUEST

(71) Applicant: QUALCOMM Incorporated, San Diego, CA (US)

(72) Inventors: Raviteja PATCHAVA, San Diego, CA (US); Jing SUN, San Diego, CA (US); Junyi LI, Greentown, PA (US); Xiaoxia ZHANG, San Diego, CA (US); Ori SHENTAL, Marlboro, NJ (US); Jing JIANG, San Diego, CA (US)

(21) Appl. No.: 18/786,358

(22) Filed: Jul. 26, 2024

(51) Int. Cl. H04W 74/0838; H04L 5/00

(52) U.S. Cl. CPC H04W 74/0838; H04L 5/0055

(57) ABSTRACT

Aspects are directed to a user equipment (UE) configured to perform a UE-initiated physical random-access channel (PRACH). For example, if the UE only performs sparce uplink communications, then certain communication parameters (e.g., timing advance) may change due to mobility, air interface conditions, and the like. Thus, instead of performing a contention-based random access (CBRA) procedure every time the UE has data to transmit, the UE may reduce signaling overhead and delays associated with the CBRA by performing a UE-initiated PRACH process.

### BACKGROUND

### Technical Field

The present disclosure generally relates to communication systems, and more particularly, to user-equipment (UE) initiated grant requests.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to a method for wireless communication at a wireless node. In some examples, the method includes generating data for transmission. In some examples, the method includes outputting, via a first set of one or more resources dedicated to a wireless node-initiated physical random-access channel (PRACH), a resource request for transmission of the generated data.

Aspects are directed to a method for wireless communication at a wireless node. In some examples, the method includes outputting an indication of: (i) a first set of one or more resources dedicated to a user equipment (UE)-initiated physical random-access channel (PRACH), and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources. In some examples, the method includes obtaining, via the first set of one or more resources, a resource request for transmission of data.

Aspects are directed to an apparatus for wireless communication. The apparatus includes one or more memories, individually or in combination, having instructions, and one or more processors, individually or in combination, configured to execute the instructions. In some examples, the one or more processors are configured to cause the apparatus to generate data for transmission. In some examples, the one or more processors are configured to cause the apparatus to output, via a first set of one or more resources dedicated to an apparatus-initiated physical random-access channel (PRACH), a resource request for transmission of the generated data.

Aspects are directed to an apparatus for wireless communication. The apparatus includes one or more memories, individually or in combination, having instructions, and one or more processors, individually or in combination, configured to execute the instructions. In some examples, the one or more processors are configured to cause the apparatus to output an indication of: (i) a first set of one or more resources dedicated to a user equipment (UE)-initiated physical random-access channel (PRACH), and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources. In some examples, the one or more processors are configured to cause the apparatus to obtain, via the first set of one or more resources, a resource request for transmission of data.

Aspects are directed to an apparatus for wireless communication. In some examples, the apparatus includes means for generating data for transmission. In some examples, the apparatus includes means for outputting, via a first set of one or more resources dedicated to a wireless node-initiated physical random-access channel (PRACH), a resource request for transmission of the generated data.

Aspects are directed to an apparatus for wireless communication. In some examples, the apparatus includes means for outputting an indication of: (i) a first set of one or more resources dedicated to a user equipment (UE)-initiated physical random-access channel (PRACH), and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources. In some examples, the apparatus includes means for obtaining, via the first set of one or more resources, a resource request for transmission of data.

Aspects are directed to a non-transitory computer-readable medium comprising instructions that, when executed by a wireless node, cause the wireless node to perform a method. In some examples, the method includes generating data for transmission. In some examples, the method includes outputting, via a first set of one or more resources dedicated to a wireless node-initiated physical random-access channel (PRACH), a resource request for transmission of the generated data.

Aspects are directed to a non-transitory computer-readable medium comprising instructions that, when executed by a wireless node, cause the wireless node to perform a method. In some examples, the method includes outputting an indication of: (i) a first set of one or more resources dedicated to a user equipment (UE)-initiated physical random-access channel (PRACH), and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources. In some examples, the method includes obtaining, via the first set of one or more resources, a resource request for transmission of data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 includes a first call-flow diagram illustrating an example of a 4-step type contention based random-access (CBRA), and a second call-flow diagram illustrating an example of a 2-step type CBRA.

FIG. 6 is a call-flow diagram illustrating a contention free random-access (CFRA) process.

FIG. 7 is a call-flow diagram illustrating example communications between a UE and a network entity that includes a UE-initiated physical random-access channel (PRACH) process.

FIG. 8 is a block diagram illustrating an example of multiple sets of preambles that include multiple preambles.

FIG. 9 is a flowchart of a method of wireless communication.

FIG. 10 is a flowchart of an additional or alternative method of wireless communication.

FIG. 11 is a flowchart of an additional or alternative method of wireless communication.

FIG. 12 is a flowchart of an additional or alternative method of wireless communication.

FIG. 13 is a flowchart of an additional or alternative method of wireless communication.

FIG. 14 is a diagram illustrating an example of a hardware implementation for an example apparatus.

FIG. 15 is another flowchart of a method of wireless communication.

FIG. 16 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the disclosure are directed to user-equipment (UE) initiated grant requests. Typically, a random access procedure may include a contention-based random access (CBRA) or a contention-free random access (CFRA). Such random access procedures may be beneficial for communication between a network entity and a UE if the communications are frequent. However, in some scenarios, UE transmissions may be sparse (e.g., infrequent uplink transmissions) and the UE-acquired timing advance (TA) from a previous communication with the network entity may no longer be valid due to one or more of timing drift, mobility, or TA expiry.

In this example scenario, if the UE has data to transmit to the network entity, the UE may perform the CBRA procedure to acquire TA and an UL resource allocation. However, the CBRA procedure for acquiring TA and UL grant may lead to a significant delay because the CBRA procedure requires the UE to randomly select a preamble and transmit msg1. This is followed by msg2 from network entity, msg3 from UE, and msg4 from network entity. Thus, the CBRA procedure can cause a significant signaling overhead if the UE is required to perform the procedure every time it has uplink data to transmit. Moreover, additional delays may result if two UEs select the same preamble for msg1, resulting in a collision and failure of the CBRA procedure. Also, because the CRFA procedure is initiated by the network entity, the UE may not be able to rely on it for sparse communications.

Thus, aspects of the disclosure are directed to UE-initiated grant requests, whereby a UE may initiate acquisition of one or both TA and uplink grant using a procedure having a reduced signaling overhead relative to a CBRA procedure.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

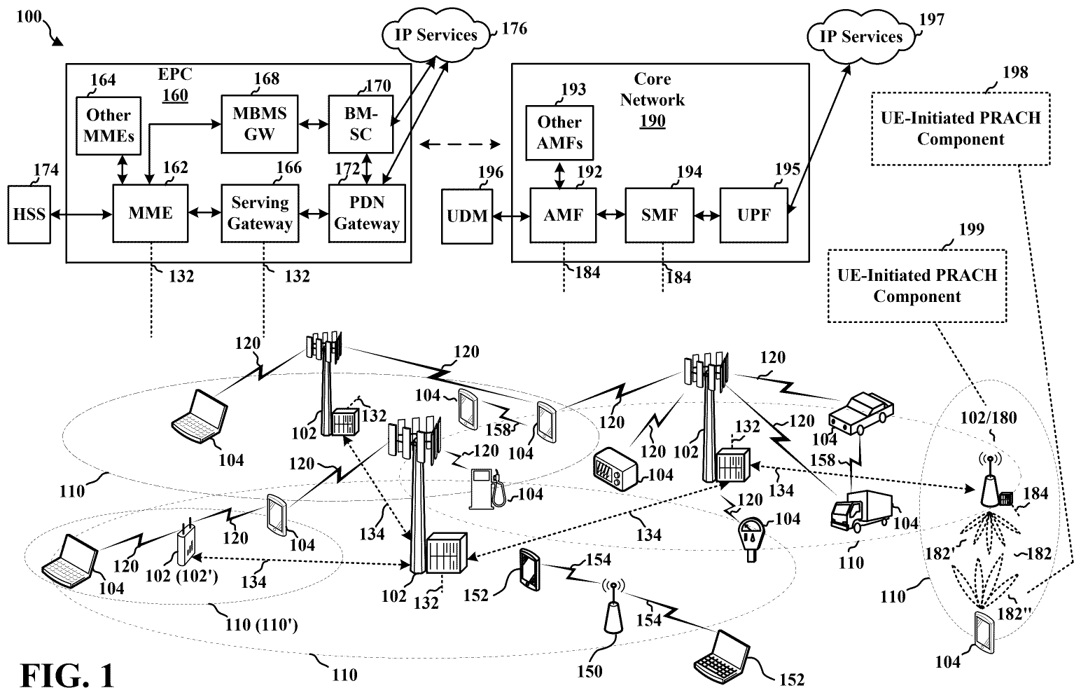

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include a UE-Initiated PRACH component 198. As described in more detail elsewhere herein, the UE-Initiated PRACH component 198 may be configured to generate data for transmission and output, via a first set of one or more resources dedicated to a wireless node-initiated physical random-access channel (PRACH), a resource request for transmission of the generated data. Additionally, or alternatively, the UE-Initiated PRACH component 198 may perform one or more other operations described herein.

The base station 102/180 may include a UE-Initiated PRACH component 199. As described in more detail elsewhere herein, the UE-Initiated PRACH component 199 may be configured to output an indication of: (i) a first set of one or more resources dedicated to a user equipment (UE)-initiated physical random-access channel (PRACH), and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources. The UE-Initiated PRACH component 199 may also be configured to obtain, via the first set of one or more resources, a resource request for transmission of data. Additionally, or alternatively, the UE-Initiated PRACH component 199 may perform one or more other operations described herein.

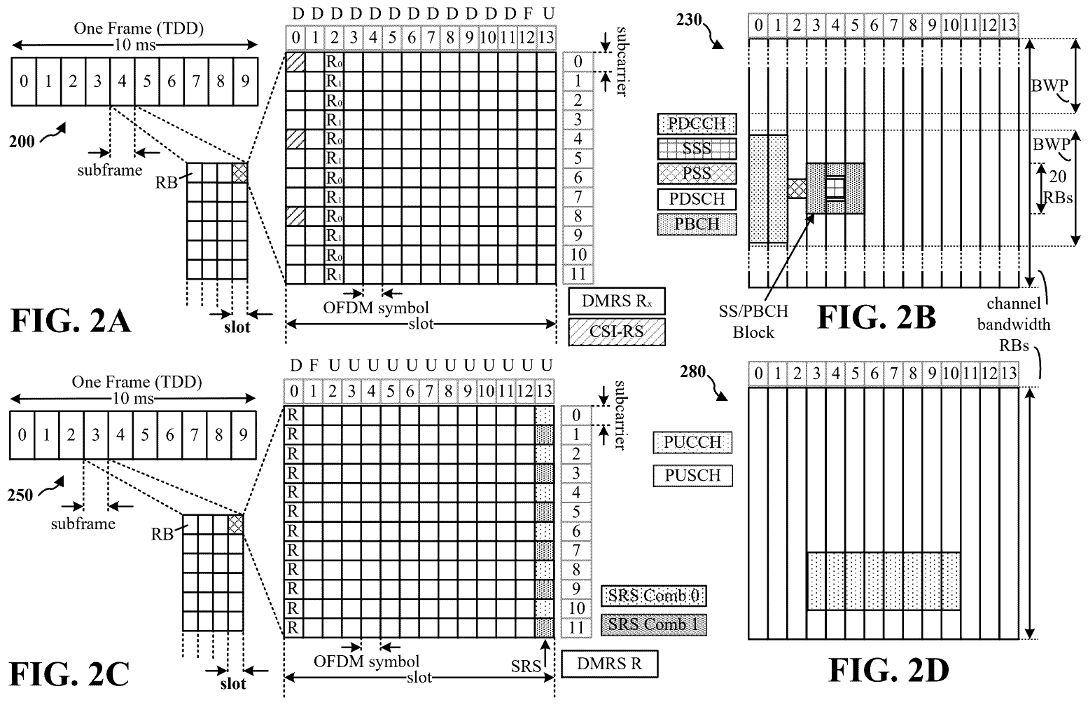

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

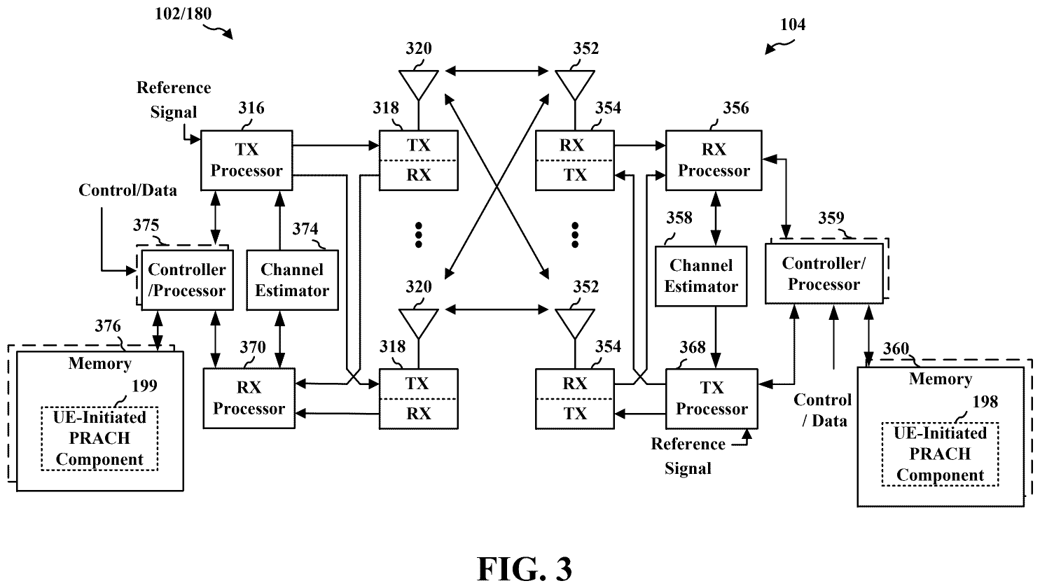

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the UE-initiated PRACH component 198 of FIG. 1.

At least one of the TX processor 316, the RX processor 370, and the controller/processor 375 may be configured to perform aspects in connection with the UE-initiated PRACH component 199 of FIG. 1.

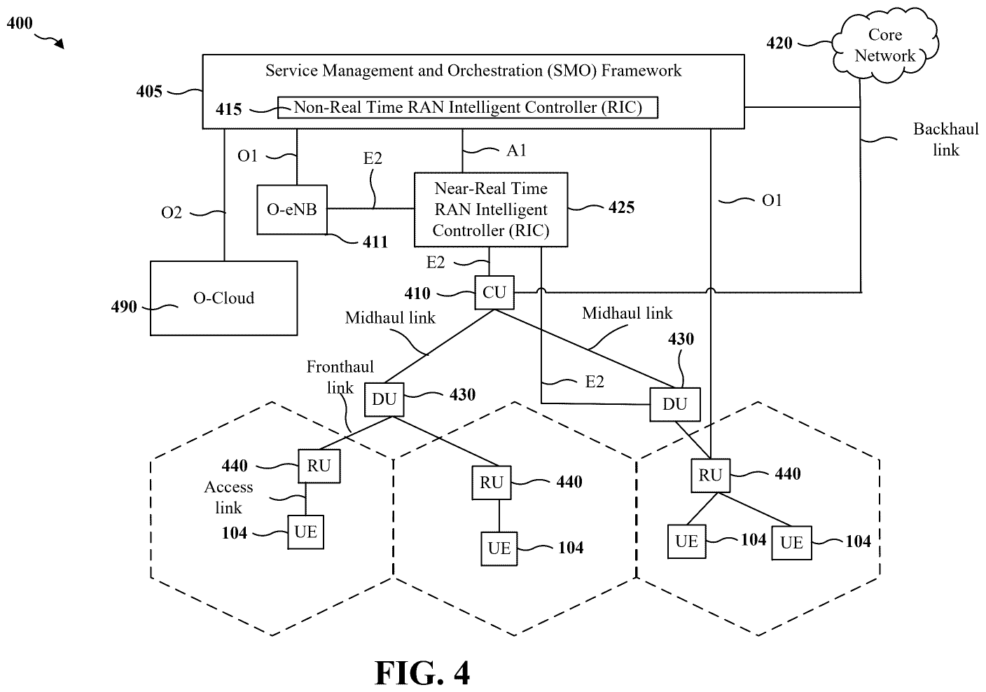

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit—user plane (CU-UP)), control plane functionality (i.e., central unit—control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the El interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an Al interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of Contention-Based Random Access (CBRA) and Contention-Free Random Access (CFRA) Procedures

A contention-based random access (CBRA) procedure is a protocol used in telecommunications networks to control access to shared resources in a network. This procedure allows multiple devices to send and receive data over a single shared channel without causing collisions. The CBRA procedure may include a 4-step physical random-access channel (PRACH) type CBRA or a 2-step PRACH type CBRA.

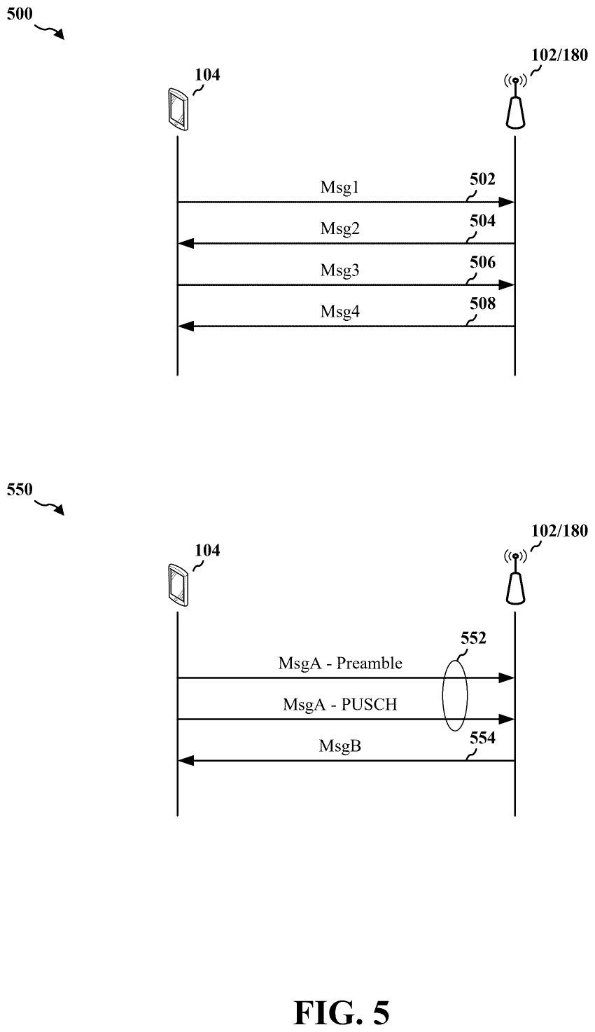

FIG. 5 includes a first call-flow diagram illustrating an example of the 4-step type 500 CBRA, and a second call-flow diagram illustrating an example of a 2-step type 550 CBRA. In the 4-step type 500 CBRA, a UE 104 may select a random-access preamble and a PRACH resource and use the PRACH resource to transmit the random access preamble to the network entity 102, via msg1 502.

The network entity 102 receives the preamble, calculates a timing advance (TA), and transmits a random-access response to the UE 104, via msg2 504. The random-access response may include information about the TA and an UL grant that the UE 104 may use to transmit msg3 506. In some examples, msg2 504 is transmitted via PDCCH and scrambled by a random-access radio network temporary identifier (RA-RNTI) that uniquely corresponds to a time-frequency resource used to transmit msg1 502. In some examples, msg2 504 may also include an indication of a preamble ID configured to notify the UE 104 that msg2 504 corresponds to the previously transmitted msg1 502.

In response to msg2 504, the UE 104 may transmit msg3 506 via resources designated by an uplink grant included in msg2. In some examples, msg3 506 may include an RRC connection establishment request. Msg4 508 may include a contention resolution message. For example, based on msg4 508, the UE 104 may determine whether the random access was successful.

The 2-step type 550 CBRA, msgA 552 includes a preamble transmission on PRACH and a payload transmission on PUSCH. It should be noted that in 4-step type 500 CBRA, the UE 104 does not transmit a PUSCH before receiving msg2 504. After transmission of msgA 552, the UE 104 may monitor for a response from the network entity 102 within a configured window of time. The network entity 102 may transmit msgB 554. If contention resolution is successful upon receiving msgB 554, the UE 104 may end the CBRA procedure.

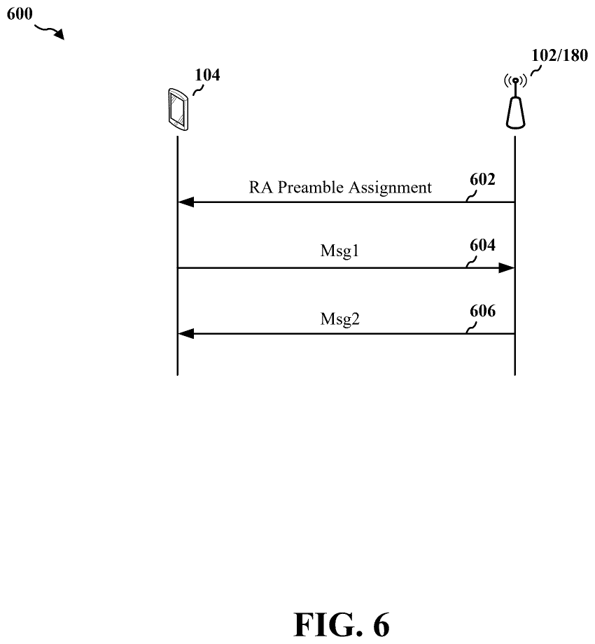

FIG. 6 is a call-flow diagram illustrating a CFRA process 600. In a first communication 602, the network entity 102 may transmit a random-access resource configuration and information of preamble structure to the UE 104. In response, the UE 104 may transmit a msg1 604 via a random-access channel configured by the network entity 102. Msg1 604 may include a random-access preamble configured by the network entity 102. The network entity 102 may then transmit msg2 606 which includes a random-access response to the UE 104. After the UE 104 receives and successfully detects a preamble identifier matching the transmitted preamble, it may be determined that the contention-free random-access process of the UE 104 succeeded.

As discussed, if the UE 104 transmits a relatively small amount or quantity of uplink transmissions over a period of time, then the UE 104 may be required to perform the 4-step type 500 CBRA for each uplink transmission due to timing drift, mobility, TA expiry, etc. This may cause significant delays in communication and may generate a high signaling overhead. Even if the UE 104 performs the 2-step type 550 CBRA for each uplink transmission instead of the 4-step, the UE 104 may experience significant delays or even longer delays than with the 4-step due to randomness. For example, the msgA PUSCH may not succeed, thereby causing the UE 104 to transmit multiple instances of the msgA PUSCH. Moreover, although the CFRA process 600 requires a relatively small number of communications, the network entity 102 must initiate it (e.g., to initiate a handover, etc.) with the first communication 602. Thus, the UE 104 may not be able to rely on the CFRA process 600 every time it has data for an uplink transmission.

### Examples of a UE-Initiated Grant Request

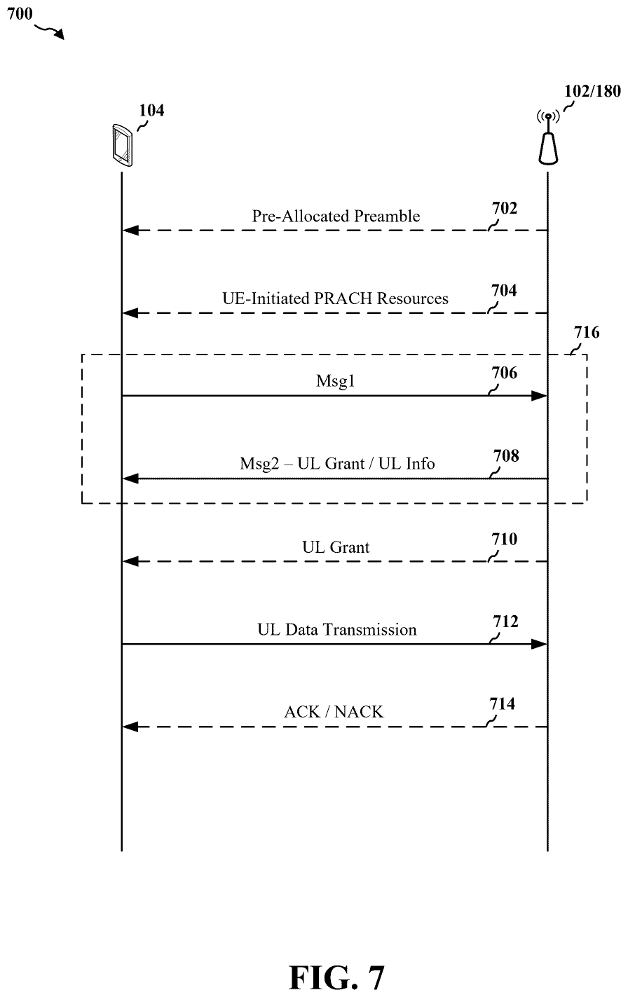

FIG. 7 is a call-flow diagram illustrating example communications 700 between a UE 104 (e.g., UE 104 of FIGS. 1 and 3) and a network entity 102 (e.g., UE 104 of FIGS. 1 and 3) that include a UE-initiated PRACH process 716. As discussed above, the CFRA process may not be a practical solution to reducing latency and signaling overhead when the UE 104 has data to transmit. Moreover, the CBRA processes already introduce a significant amount of signaling overhead and latency to communications between the UE 104 and network entity 102. Thus, the UE 104 may perform the UE-initiated PRACH process 716 to quickly obtain one or more of timing advance (TA) information and/or an uplink grant from the network entity 102.

In some examples, the UE 104 may optionally perform a 4-step or 2-step type CBRA process with the network entity 102 and establish an RRC connection between the UE 104 and the network entity 102. If the RRC connection is established, the network entity 102 may assign a pre-allocated preamble to the UE 104 via RRC messaging or other suitable messaging (e.g., DCI or MAC-CE). For example, if the UE 104 transmits an uplink grant request to the network entity 102 in an RRC connected mode, then the network entity 102 may determine a pre-allocated preamble for the UE 104, and transmit, via an optional first communication 702, an indication of the preamble to the UE 104. The pre-allocated preamble may be configured to uniquely identify the UE 104 and distinguish the UE 104 from other UEs that communicate with the network entity 102. Accordingly, the UE 104 may include the pre-allocated preamble in any uplink grant request it transmits to the network entity 102.

It should be noted that the UE 104 may include the pre-allocated preamble in an uplink grant request regardless of whether the RRC connection is maintained. For example, if the RRC connection is lost, the UE 104 may include the pre-allocated preamble in the UE-initiated PRACH process 716. For example, if the RRC connection between the UE 104 and the network entity 102 is dropped, the UE 104 may perform the UE-initiated PRACH process 716 and include an indication of the assigned preamble in msg1 (e.g., third communication 706). In some examples, the UE 104 may perform the UE-initiated PRACH process 716 even when an RRC connection exists between the UE 104 and the network entity 102.

Thus, the network entity 102 may pre-allocate a unique preamble to the UE 104 during or after an RRC connection is established so that when the UE 104 transmits the third communication 706, the network entity 102 can identify which UE is transmitting the third communication 706. The unique preamble may also be configured to implicitly indicate to the network entity 102 that the UE 104 is trying to acquire TA information and/or an uplink grant.

At an optional second communication 704, the network entity 102 may configure and transmit an indication of resources dedicated to the UE-initiated PRACH process 716. That is, the network entity 102 transmit, to the UE 104, an indication of resources that, if used by the UE 104 to transmit signaling to the network entity 102, will implicitly indicate to the network entity 102 that the UE 104 is performing the UE- initiated PRACH process 716. For example, these dedicated resources may be separate from resources used for CBRA and CFRA, and thus, if the network entity receives signaling from the UE 104 via these dedicated resources, the network entity 102 may determine that the purpose of the signaling is for the UE 104 to acquire TA information and/or uplink grant.

In certain aspects, the dedicated resources may be sequences separated (e.g., in frequency and/or time) from resources used for CBRA and CFRA communications. In some examples, the dedicated resources may be new RACH opportunities (ROs) (e.g., new time and frequency resources) defined separately from CBRA and CFRA resources. For example, if there are four RACH opportunities ROs, two may be allocated for CBRA/CFRA communications, and the other two may be allocated as dedicated resources for UE-initiated PRACH communications. In some examples, the dedicated resources may be associated with different cyclic shifts relative to CBRA/CFRA resources. The network entity 102 may transmit or broadcast an indication of the dedicated resources via a MIB or SIB, or, via RRC message, DCI, or MAC-CE if an RRC connection exists between the network entity 102 and the UE 104.

In certain aspects, the network entity 102 may divide the dedicated resources into a plurality of different sets of preamble sequences, with each set of preamble sequences being associated with one or more parameters: e.g., a number of resources required for an uplink transmission, an MCS for the uplink transmission, and/or a number of layers for the uplink transmission.

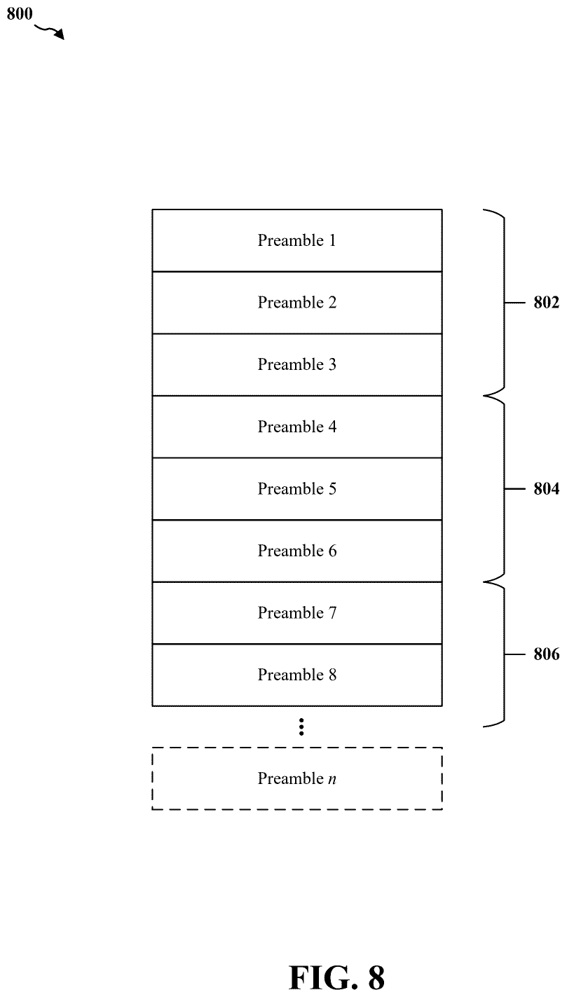

For example, the network entity 102 may associate multiple sets of preambles to one or more communication parameters, where each of the preambles is dedicated for use in the UE-initiated PRACH process 716 (e.g., msg1 of the third communication 706). For example, as illustrated in FIG. 8, the network entity 102 may associate a first set of preambles 802 (e.g., preambles 1-3) to a first communication parameter, a second set of preambles 804 (e.g., preambles 4-6) to a second communication parameter, and a third set of preambles 806 (e.g., preambles 7 and 8) to a third communication parameter. The network entity 102 may transmit or broadcast an indication of the sets of dedicated preambles and the association between the sets and the communication parameters via a MIB or SIB, or, via RRC message, DCI, or MAC-CE if an RRC connection exists between the network entity 102 and the UE 104. It should be noted that although FIG. 8 illustrates each set of preambles as includes multiple preambles, each set may include any suitable amount or quantity of preambles, including one. Moreover, the network entity 102 may configure an association between any suitable quantity of preambles and any suitable quantity of sets.

Thus, for example, the first set of preambles 802 may be associated with a first range of resources for an uplink communication (e.g., less than or equal to 6 resource blocks (RBs)), the second set of preambles 804 may be associated with a second range of resources for the uplink communication (e.g., greater than or equal to 7 RBs and less than or equal to 99 RBs), and the third set of preambles 806 may be associated with a third range of resources for the uplink communication (e.g., greater than or equal to 100 RBs). Accordingly, the UE 104 may select a set of preambles based on the size of a future uplink transmission, then randomly select one of the preambles of the appropriate set. Then, at the third communication 706, the UE 104 may include an indication of the randomly selected preamble in msg1. Thus, msg1 may implicitly indicate the quantity of resources required by the UE 104 for its uplink transmission to the network entity 102 based on which preamble is included in the msg1. The network entity 102 may then determine and schedule the uplink transmission with a proper quantity of resources. In some examples, the msg1 of the UE-initiated PRACH process 716 may not include an explicit indication of communication parameters required for the uplink transmission, such as an MCS, the quantity of resources needed for the UL transmission, the number of layers required for the uplink transmission, etc. Thus, an implicit indication of one or more communication parameters associated with the uplink transmission may be provided to the network entity 102 based on which set of preambles the randomly selected preamble is a part of.

In some examples, the network entity 102 may associate each set of preambles with one or more communication parameters such as an MCS, the quantity of resources needed for the UL transmission, the number of layers required for the uplink transmission, etc. In some examples, the different sets of preambles may be cell-specific or UE-specific sets of UE-initiated PRACH preamble sequences.

At the third communication 706, the UE 104 may initiate the UE-initiated PRACH process 716 by transmitting msg1 to the network entity 102. As discussed, the UE 104 may not have an RRC connection with the network entity 102, and the UE 104 may infrequently have uplink data to transmit to the network entity 102. Thus, instead of using a CBRA or CFRA procedure, the UE 104 may reduce latency and signaling overhead associated with the CBRA and CFRA procedures by performing the UE-initiated PRACH process 716.

Regarding msg1, if there was no previous or existing RRC connection between the network entity 102 and the UE 104, then the network entity 102 may not have any identifying information associated with the UE 104. Accordingly, the UE 104 may select a preamble randomly (e.g., from preambles indicated in a SIB, or from a set of preambles corresponding to an appropriate communication parameter) and include an indication of the randomly selected preamble in msg1. In response, the network entity 102 may transmit msg2 (e.g., a fourth communication 708) that includes TA information and/or an uplink grant, and an indication of the preamble (e.g., a random access RNTI (RA-RNTI) or random-access preamble ID (RAPID)) matching the preamble transmitted by the UE in msg1. Alternatively, if there was a previous or is an existing RRC connection between the network entity 102 and the UE 104, then the UE 104 may transmit an indication of the pre-allocated preamble received in the optional first communication 702 in the msg1.

At the fourth communication 708 (e.g., second and last communication of the UE-initiated PRACH process 716), the network entity 102 may transmit an indication of TA information and/or an uplink grant to the UE 104 based on msg1. In some examples, msg2 may include one or more of: TA information for the uplink transmission that corresponds to the detected preamble, power control information for the uplink transmission, an indication of a TC-RNTI or C-RNTI that the UE 104 may include in its uplink transmission, and any other suitable information. Accordingly, when the UE 104 transmits the uplink transmission (e.g., sixth communication 712) via the resources indicated by the uplink grant, the uplink transmission may be transmitted according to the TA and power control information, and may include an identifier such as the TC-RNTI or C-RNTI. Msg2 may also include additional details about the uplink transmission such as: RB allocation (e.g., time and frequency resources via which the uplink signaling is transmitted), an MCS for the uplink transmission, a number of layers, a precoder, etc.

In some examples, msg2 may be configured to indicate to the UE 104 that the network entity 102 will transmit the uplink grant to the UE 104 in a DCI via PDCCH. In this example, the UE 104 may expect to receive a DCI (e.g., an optional fifth communication 710) from the network entity 102 prior to the uplink transmission. The DCI may include one or more of the TA information, the power control information, the indication of TC-RNTI or C-RNTI, RB allocation, the MCS, the number of layers, the precoder, etc.

At a sixth communication 712, the UE 104 may transmit the uplink transmission according to the TA information and uplink grant received in msg2. In some examples, the uplink transmission may include an indication of a UE identifier (e.g., TC-RNTI/C-RNTI associated with the randomly selected preamble of msg1) in either the UCI or the payload of the uplink transmission. The network entity 102 may decode this information to determine which UE is transmitting.

At an optional seventh communication 714, the network entity 102 may transmit an ACK/NACK or an indication of resources for retransmission of the uplink communication to the UE 104 in response to the uplink transmission of the sixth communication 712. In some examples, the ACK/NACK may be transmitted via DCI. In one such example, the network entity 102 may scramble the CRC bits of the DCI using the TC-RNTI/C-RNTI indicated in the uplink transmission and msg2.

If an ACK is transmitted in the seventh communication 714, then in some examples, the network entity 102 may also include, in the seventh communication 714, the first one or more bits the network entity 102 received in the uplink transmission. The UE 104 may identify the ACK response and its context (e.g., that the ACK is associated with the uplink transmission) based on the inclusion of the first one or more bits. The first one or more bits may include bits from one or more of the payload and/or the TC-RNTI/C-RNTI of the uplink transmission.

If the network entity 102 is unsuccessful in decoding the uplink transmission, then the network entity may transmit, via DCI, an indication of a resource allocation for retransmission of the uplink transmission. The DCI may be formatted using CRC bits scrambled using the TC-RNTI/C-RNTI of msg2 or, if at least partially decoded, the uplink transmission. The DCI may also indicate that the UE 104 may use an increased transmit power (e.g., relative to the uplink transmission of the sixth communication 712) for retransmission of the uplink transmission.

In some examples, the network entity 102 may detect a collision associated with the uplink transmission. In such an example, the network entity 102 may refrain from transmitting a NACK or an indication of allocated retransmission resources. Instead, the network entity 102 may allow for an ACK timer to expire. For example, upon transmitting the uplink transmission of the sixth communication 712, the UE 104 may start a timer. If the timer expires before the UE 104 receives an ACK/NACK from the network entity 102 in response to the uplink transmission, then the UE 104 may restart the UE-initiated PRACH process 716 by retransmitting msg1 of the third communication 706. In some examples, instead of an ACK/NACK, the seventh communication 714 may include an indication of the detected collision. After receiving and decoding the seventh communication 714, the UE 104 may respond by restarting the UE-initiated PRACH process 716 and retransmitting msg1.

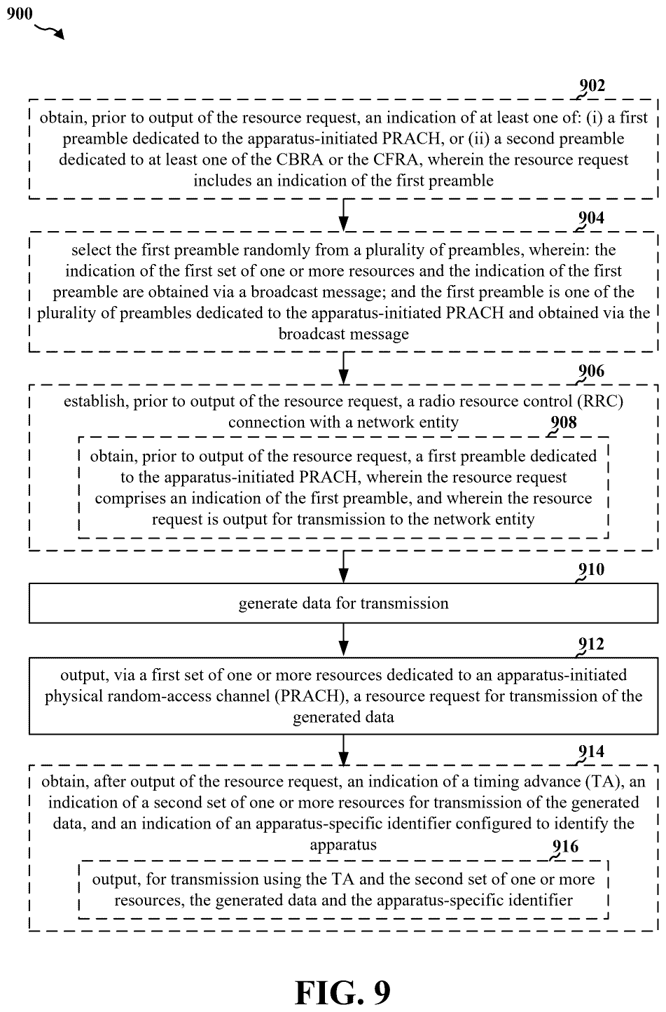

FIG. 9 is a flowchart illustrating a method 900 of wireless communication. The method may be performed by a UE (e.g., the UE 104; the apparatus 1402). Specifically, the method may be performed by one or more memories, processors, and RF front ends (e.g., the memory 360, controller/processor 359, transmitter 354TX, receiver 354RX, antenna 352, etc. of FIG. 3).

At 902, the UE may optionally obtain, prior to output of the resource request, an indication of at least one of: (i) a first preamble dedicated to the apparatus-initiated PRACH, or (ii) a second preamble dedicated to at least one of the CBRA or the CFRA, wherein the resource request includes an indication of the first preamble. For example, 902 may be performed by the obtaining component 1440. Here, the network entity may transmit, to the UE, one or more dedicated preambles (e.g., sequences) for the UE-initiated PRACH. Thus, the UE may include an indication of a dedicated preamble in msg1 of the UE-initiated PRACH (e.g., third communication 706 of FIG. 7). Thus, when the network entity receives msg1, it can determine, based on the preamble, that the UE is performing a UE-initiated PRACH. In some examples, the network entity may also transmit one or more different preambles dedicated to CBRA and/or CFRA. This way, the UE does not use the same preamble for CBRA/CFRA and UE-initiated PRACH, and the network entity can determine, based on the preamble, which random access procedure the UE is performing.

At 904, the UE may optionally select the first preamble randomly from a plurality of preambles, wherein: the indication of the first set of one or more resources and the indication of the first preamble are obtained via a broadcast message; and the first preamble is one of the plurality of preambles dedicated to the apparatus-initiated PRACH and obtained via the broadcast message. For example, 904 may be performed by the selecting component 1442. Here, the UE may receive a signaling (e.g., MIB/SIB) from the network entity, where the signaling comprises: (i) an indication of a plurality of preambles including the first preamble, and (ii) one or more resources (e.g., time and/or frequency resources) for transmitting the first preamble to perform a random-access procedure with the network entity. In some examples, the signaling may indicate that at least one of the one or more resources or the plurality of preambles is dedicated to the UE-initiated PRACH process. Thus, if the UE transmits msg1 (e.g., third communication 706 of FIG. 7), via the dedicated resources and/or using one of the plurality of preambles, the network entity may determine that the UE is performing the UE-initiated PRACH instead of a CBRA/CFRA process.

At 906, the UE may optionally establish, prior to output of the resource request, a radio resource control (RRC) connection with a network entity. For example, 906 may be performed by the establishing component 1444. Although aspects of the disclosure are directed to the UE using a UE-initiated PRACH process to obtain resources and TA for an uplink transmission without having an RRC connection with the network entity, in other aspects, the UE may establish an RRC connection with the network entity prior to performing the UE-initiated PRACH. Accordingly, the UE may establish an RRC connection with the network entity prior to receiving the dedicated resource(s) and/or dedicated preamble(s) for transmitting msg1 of the UE-initiated PRACH.

At 908, the UE may optionally obtain, prior to output of the resource request, a first preamble dedicated to the apparatus-initiated PRACH, wherein the resource request comprises an indication of the first preamble, and wherein the resource request is output for transmission to the network entity. For example, 908 may be performed by the obtaining component 1440. Here, after the UE has established an RRC connection with the network entity, the network entity may transmit to the UE via RRC messaging, with an indication of one or more preambles and/or resources dedicated to UE-initiated PRACH. Even if the RRC connection is lost or inactive at a future time, the UE may still use the dedicated preambles and/or resources to transmit msg 1 of the UE-initiated PRACH.

At 910, the UE may generate data for transmission. For example, 910 may be performed by the generating component 1446. Here, the UE may generate data for uplink transmission to the network entity.

At 912, the UE may output, via a first set of one or more resources dedicated to an apparatus-initiated physical random-access channel (PRACH), a resource request for transmission of the generated data. For example, 912 may be performed by the outputting component 1448. Here, the UE may use resources dedicated to the UE-initiated PRACH process to transmit msg1.

At 914, the UE may optionally obtain, after output of the resource request, an indication of a timing advance (TA), an indication of a second set of one or more resources for transmission of the generated data, and an indication of an apparatus-specific identifier configured to identify the apparatus. For example, 914 may be performed by the obtaining component 1440. Here, the network entity may transmit an indication of resources (e.g., uplink grant associated with the fourth communication 708 or the optional fifth communication 710 of FIG. 7) by which the UE may transmit uplink data (e.g., uplink data transmission associated with the sixth communication 712 of FIG. 7). The indication of resources may include an identifier that the UE may include in its transmission of uplink data. The identifier may be used by the network entity to determine that the uplink transmission came from the UE.

At 916, the UE may optionally output, for transmission using the TA and the second set of one or more resources, the generated data and the apparatus-specific identifier. For example, 912 may be performed by the outputting component 1448. Here, the UE may transmit uplink data using the resources indicated by the uplink grant and the identifier provided by the network entity.

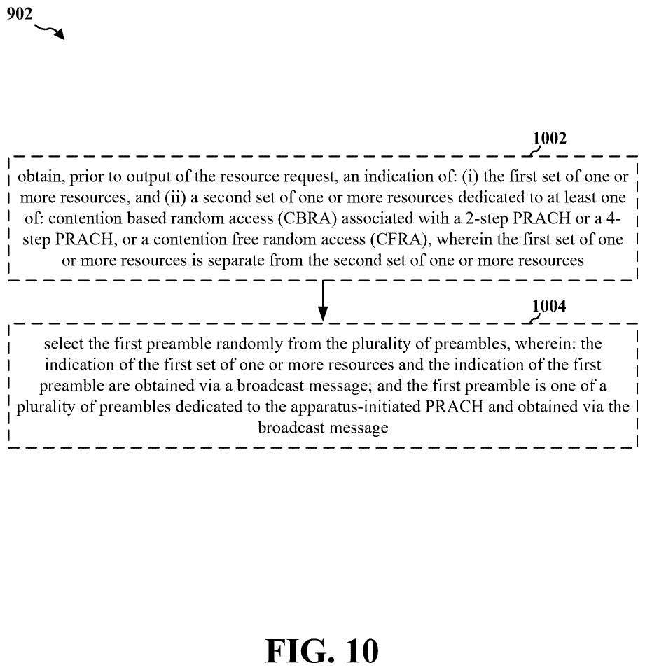

Referring to FIG. 10, in an alternative or additional aspect, at 1002, the UE may optionally obtain, prior to output of the resource request, an indication of: (i) the first set of one or more resources, and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources. For example, 1002 may be performed by the obtaining component 1440. Here, the network entity may transmit, and the UE may receive, an indication of resources dedicated to the UE-initiated PRACH, and an indication of resources dedicated to a CBRA/CFRA process.

At 1004, the UE may optionally select the first preamble randomly from the plurality of preambles, wherein: the indication of the first set of one or more resources and the indication of the first preamble are obtained via a broadcast message; and the first preamble is one of a plurality of preambles dedicated to the apparatus-initiated PRACH and obtained via the broadcast message. For example, 1004 may be performed by the selecting component 1442. Here, the UE may receive an indication of UE-initiated PRACH resources and/or preambles via a broadcast message (e.g., MIB/SIB) and may select a preamble for msg1 of the UE-initiated PRACH randomly.

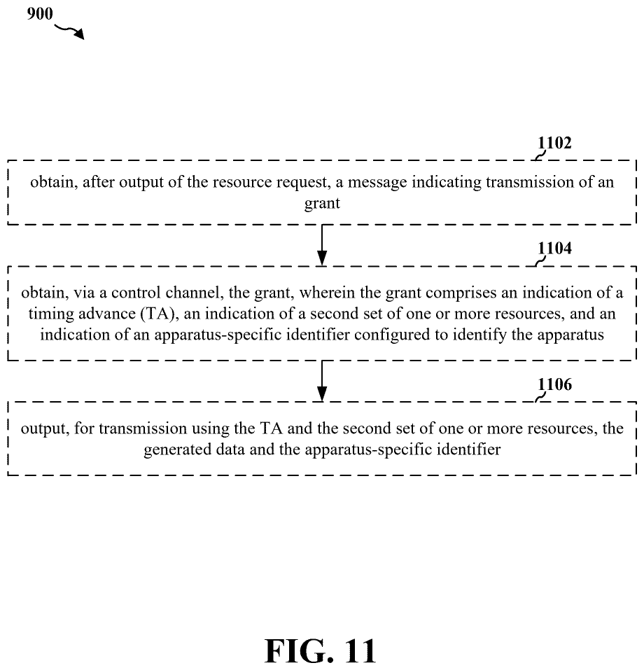

Referring to FIG. 11, in an alternative or additional aspect, at 1102, the UE may optionally obtain, after output of the resource request, a message indicating transmission of a grant. For example, 1102 may be performed by the obtaining component 1440. Here, in response to msg1 transmitted by the UE, the network entity may transmit an uplink grant (e.g., uplink grant associated with the fourth communication 708 or the optional fifth communication 710 of FIG. 7).

At 1104, the UE may optionally obtain, via a control channel, the grant, wherein the grant comprises an indication of a timing advance (TA), an indication of a second set of one or more resources, and an indication of an apparatus-specific identifier configured to identify the apparatus. For example, 1104 may be performed by the obtaining component 1440. Here, the UE may receive the grant via a control channel (e.g., PDCCH) and the grant may include a TA that the UE may use for transmitting the uplink data. The grant may also include a UE-specific identifier that the UE may include in the uplink data transmission, and resources via which the UE may transmit the uplink data.

At 1106, the UE may optionally output, for transmission using the TA and the second set of one or more resources, the generated data and the apparatus-specific identifier. For example, 1106 may be performed by the outputting component 1448.

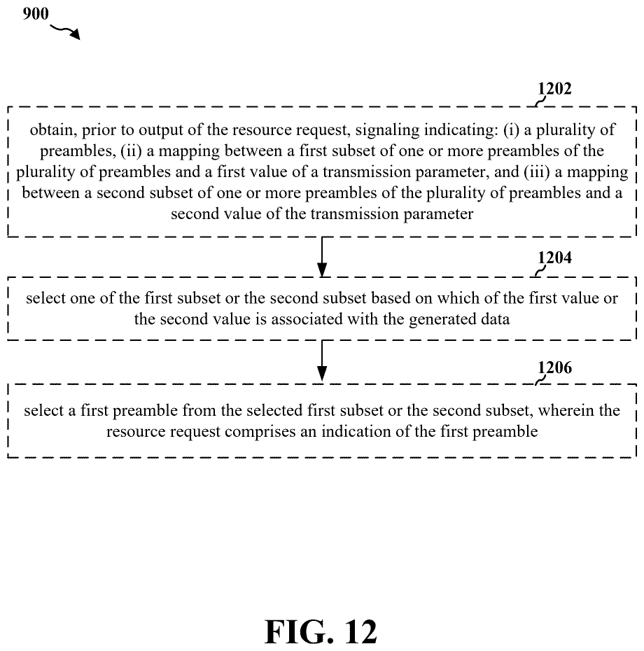

Referring to FIG. 12, in an alternative or additional aspect, at 1202, the UE may optionally obtain, prior to output of the resource request, signaling indicating: (i) a plurality of preambles, (ii) a mapping between a first subset of one or more preambles of the plurality of preambles and a first value of a transmission parameter, and (iii) a mapping between a second subset of one or more preambles of the plurality of preambles and a second value of the transmission parameter. For example, 1202 may be performed by the obtaining component 1440. Here, the network entity may transmit (e.g., via broadcast, RRC messaging, DCI, or MAC-CE) an indication of a plurality of preambles, and an indication of a mapping between a first subset (e.g., less than all of the plurality of preambles) of preambles and a first value of a transmission parameter. In other words, the first subset may be mapped to a particular size of the uplink transmission by the UE, an MCS used by the UE for uplink transmissions, and/or a number of layers used by the UE for uplink transmissions. As such, when the UE uses a particular preamble in msg1, the network entity may determine an appropriate allocation of resources and provide an indication of those resources in an uplink grant (e.g., msg2). Other subsets of the preambles may be mapped to other transmission parameters.

At 1204, the UE may optionally select one of the first subset or the second subset based on which of the first value or the second value is associated with the generated data. For example, 1204 may be performed by the selecting component 1442. Here, the UE may select (e.g., randomly) a preamble from a subset of the preambles that corresponds to an appropriate transmission parameter. For example, if the size of the uplink data that the UE needs to transmit is less than 6 RBs, and a first subset of parameters is mapped to an uplink data size of less than 6 RBs, then the UE may randomly select a preamble from the first subset of preambles and include the randomly selected preamble in msg1.

At 1206, the UE may optionally select a first preamble from the selected first subset or the second subset, wherein the resource request comprises an indication of the first preamble. For example, 1204 may be performed by the selecting component 1442. Here, msg1 of the UE-initiated PRACH process may include an indication of the randomly selected preamble.

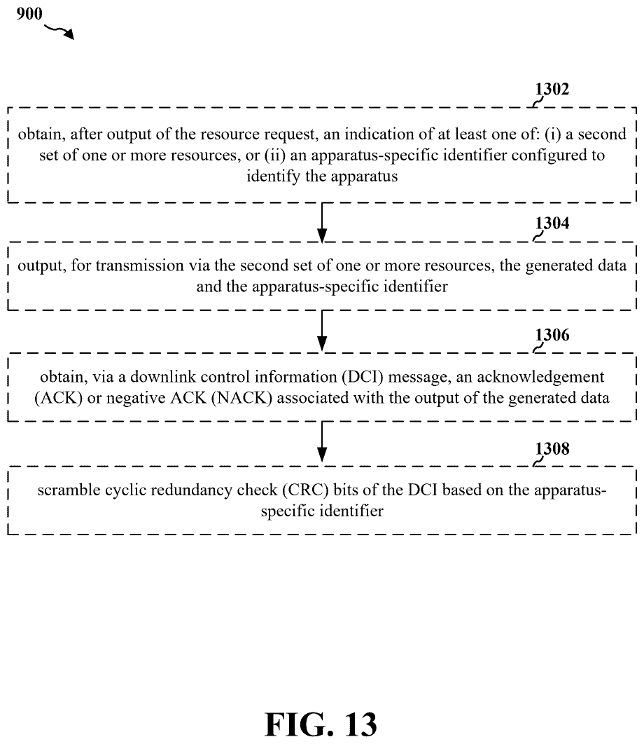

Referring to FIG. 13, in an alternative or additional aspect, at block 1302, the UE may optionally obtain, after output of the resource request, an indication of at least one of: (i) a second set of one or more resources, or (ii) an apparatus-specific identifier configured to identify the apparatus. For example, 1302 may be performed by the obtaining component 1440. Here, in response to msg1 of the UE-initiated PRACH transmitted by the UE, the network entity may provide the UE an uplink grant configured to indicate resources for the uplink transmission and, in some examples, a UE identifier that the UE may include in the uplink transmission so that the network entity can identify the UE transmitting the uplink data.

At 1304, the UE may optionally output, for transmission via the second set of one or more resources, the generated data and the apparatus-specific identifier. For example, 1304 may be performed by the outputting component 1448. Here, the UE may transmit uplink data using the resources and UE-specific ID provided by the network entity in the uplink grant.

At 1306, the UE may optionally obtain, via a downlink control information (DCI) message, an acknowledgement (ACK) or negative ACK (NACK) associated with the output of the generated data. For example, 1306 may be performed by the obtaining component 1440.

At 1308, the UE may scramble cyclic redundancy check (CRC) bits of the DCI based on the apparatus-specific identifier. For example, 1308 may be performed by the scrambling component 1450.

In certain aspects, the indication of the second set of one or more resources comprises one or more of: a resource block allocation, a modulation and coding scheme (MCS), a quantity of layers, and a precoder.

In certain aspects, the apparatus-specific identifier is obtained via a control channel associated with the second set of one or more resources or a shared channel associated with the second set of one or more resources.

In certain aspects, the resource request is output for transmission to a network entity independent of a radio resource control (RRC) connection between the apparatus and the network entity. In other words, the UE may transmit msg1 to the network entity whether it has an RRC connection with the network entity or not. Thus, if there is no RRC connection (e.g., RRC connection never established or RRC connection dropped) between the UE and the network entity, the UE may still perform the UE-initiated PRACH process.

In certain aspects, the first preamble is an apparatus-specific preamble.

In certain aspects, each of the plurality of preambles is dedicated to the apparatus-initiated PRACH.

In certain aspects, the transmission parameter comprises at least one of: (i) a range of resources to be used for transmission of the generated data, (ii) a modulation and coding scheme (MCS) to be used for transmission of the generated data, or (iii) a quantity of layers to be used for transmission of the generated data.

In certain aspects, at least one of: the first preamble is selected randomly, or the signaling is obtained via one or more of a master information block (MIB) and a system information block (SIB).

In certain aspects, the ACK is obtained via the DCI, and wherein the DCI comprises one or more bits of the generated data.

In certain aspects, the NACK is obtained via the DCI, wherein the DCI comprises a resource allocation for retransmission of the generated data.

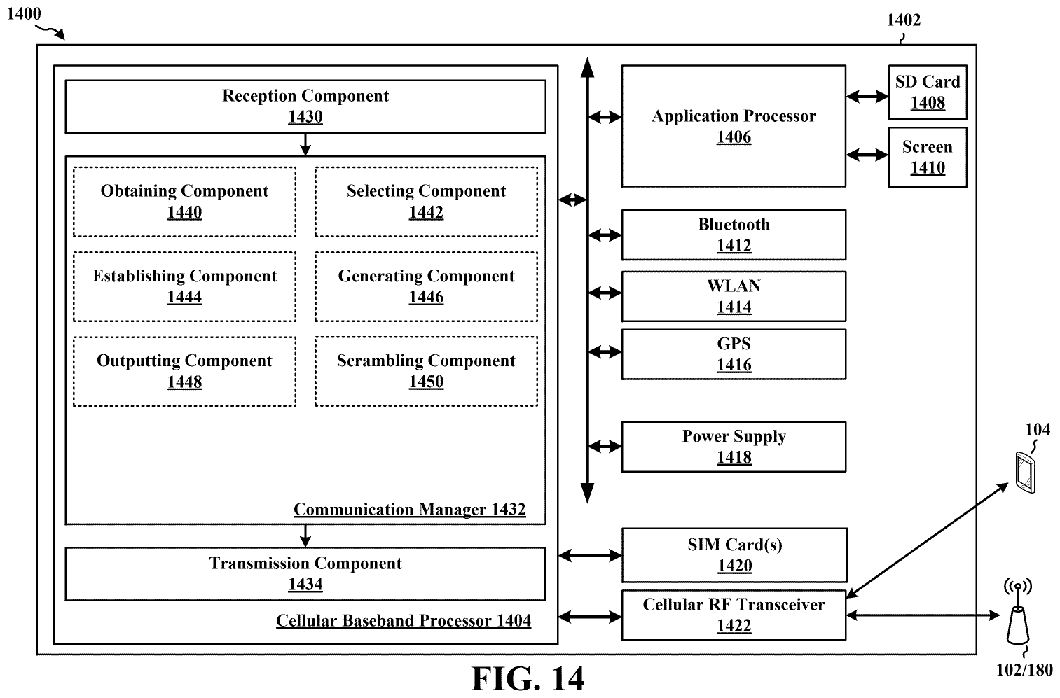

FIG. 14 is a diagram 1400 illustrating an example of a hardware implementation for an apparatus 1402. The apparatus 1402 is a UE and includes a cellular baseband processor 1404 (also referred to as a modem) coupled to one or more cellular RF transceivers 1422 and one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, and a power supply 1418. The cellular baseband processor 1404 communicates through the one or more cellular RF transceivers 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 104 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., sec UE 104 of FIG. 3) and include the aforediscussed additional modules of the apparatus 1402. In various examples, the apparatus 1402 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1432 includes an obtaining component 1440 that is configured to: obtain, prior to output of the resource request, an indication of at least one of: (i) a first preamble dedicated to the apparatus-initiated PRACH, or (ii) a second preamble dedicated to at least one of the CBRA or the CFRA, wherein the resource request includes an indication of the first preamble; obtain, prior to output of the resource request, a first preamble dedicated to the apparatus-initiated PRACH, wherein the resource request comprises an indication of the first preamble, and wherein the resource request is output for transmission to the network entity; obtain, after output of the resource request, an indication of a timing advance (TA), an indication of a second set of one or more resources for transmission of the generated data, and an indication of an apparatus-specific identifier configured to identify the apparatus; obtain, prior to output of the resource request, an indication of: (i) the first set of one or more resources, and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources; obtain, after output of the resource request, a message indicating transmission of an grant; obtain, via a control channel, the grant, wherein the grant comprises an indication of a timing advance (TA), an indication of a second set of one or more resources, and an indication of an apparatus-specific identifier configured to identify the apparatus; obtain, prior to output of the resource request, signaling indicating: (i) a plurality of preambles, (ii) a mapping between a first subset of one or more preambles of the plurality of preambles and a first value of a transmission parameter, and (iii) a mapping between a second subset of one or more preambles of the plurality of preambles and a second value of the transmission parameter; obtain, after output of the resource request, an indication of at least one of: (i) a second set of one or more resources, or (ii) an apparatus-specific identifier configured to identify the apparatus; and obtain, via a downlink control information (DCI) message, an acknowledgement (ACK) or negative ACK (NACK) associated with the output of the generated data; e.g., as described in connection with 902, 908, 914, 1002, 1102, 1104, 1202, 1302, and 1306.

The communication manager 1432 includes a selecting component 1442 that is configured to: select the first preamble randomly from a plurality of preambles, wherein: the indication of the first set of one or more resources and the indication of the first preamble are obtained via a broadcast message; and the first preamble is one of the plurality of preambles dedicated to the apparatus-initiated PRACH and obtained via the broadcast message; select the first preamble randomly from the plurality of preambles, wherein: the indication of the first set of one or more resources and the indication of the first preamble are obtained via a broadcast message; and the first preamble is one of a plurality of preambles dedicated to the apparatus-initiated PRACH and obtained via the broadcast message; select one of the first subset or the second subset based on which of the first value or the second value is associated with the generated data; and select a first preamble from the selected first subset or the second subset, wherein the resource request comprises an indication of the first preamble; e.g., as described in connection with 904, 1004, 1204, and 1206.

The communication manager 1432 includes an establishing component 1444 that is configured to establish, prior to output of the resource request, a radio resource control (RRC) connection with a network entity, e.g., as described in connection with 906.

The communication manager 1432 includes a generating component 1446 that is configured to generate data for transmission, e.g., as described in connection with 910.

The communication manager 1432 includes an outputting component 1448 that is configured to: output, via a first set of one or more resources dedicated to an apparatus-initiated physical random-access channel (PRACH), a resource request for transmission of the generated data; output, for transmission using the TA and the second set of one or more resources, the generated data and the apparatus-specific identifier; output, for transmission using the TA and the second set of one or more resources, the generated data and the apparatus-specific identifier; and output, for transmission via the second set of one or more resources, the generated data and the apparatus-specific identifier; e.g., as described in connection with 912, 916, and 1304.

The communication manager 1432 includes a scrambling component 1450 that is configured to scramble cyclic redundancy check (CRC) bits of the DCI based on the apparatus-specific identifier, e.g., as described in connection with 1308.

The apparatus may include additional components that perform each of the blocks of the algorithm in the aforementioned flowcharts of FIGS. 9-13. As such, each block in the aforementioned flowcharts of FIGS. 9-13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the cellular baseband processor 1404, includes: means for obtaining, prior to output of the resource request, an indication of at least one of: (i) a first preamble dedicated to the apparatus-initiated PRACH, or (ii) a second preamble dedicated to at least one of the CBRA or the CFRA, wherein the resource request includes an indication of the first preamble; means for selecting the first preamble randomly from a plurality of preambles, wherein: the indication of the first set of one or more resources and the indication of the first preamble are obtained via a broadcast message; and the first preamble is one of the plurality of preambles dedicated to the apparatus-initiated PRACH and obtained via the broadcast message; means for establishing, prior to output of the resource request, a radio resource control (RRC) connection with a network entity; means for obtaining, prior to output of the resource request, a first preamble dedicated to the apparatus-initiated PRACH, wherein the resource request comprises an indication of the first preamble, and wherein the resource request is output for transmission to the network entity; means for generating data for transmission; means for outputting, via a first set of one or more resources dedicated to an apparatus-initiated physical random-access channel (PRACH), a resource request for transmission of the generated data; means for obtaining, after output of the resource request, an indication of a timing advance (TA), an indication of a second set of one or more resources for transmission of the generated data, and an indication of an apparatus-specific identifier configured to identify the apparatus; means for outputting, for transmission using the TA and the second set of one or more resources, the generated data and the apparatus-specific identifier; means for obtaining, prior to output of the resource request, an indication of: (i) the first set of one or more resources, and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources; means for selecting the first preamble randomly from the plurality of preambles, wherein: the indication of the first set of one or more resources and the indication of the first preamble are obtained via a broadcast message; and the first preamble is one of a plurality of preambles dedicated to the apparatus-initiated PRACH and obtained via the broadcast message; means for obtaining, after output of the resource request, a message indicating transmission of an grant; means for obtaining, via a control channel, the grant, wherein the grant comprises an indication of a timing advance (TA), an indication of a second set of one or more resources, and an indication of an apparatus-specific identifier configured to identify the apparatus; means for outputting, for transmission using the TA and the second set of one or more resources, the generated data and the apparatus-specific identifier; means for obtaining, prior to output of the resource request, signaling indicating: (i) a plurality of preambles, (ii) a mapping between a first subset of one or more preambles of the plurality of preambles and a first value of a transmission parameter, and (iii) a mapping between a second subset of one or more preambles of the plurality of preambles and a second value of the transmission parameter; means for selecting one of the first subset or the second subset based on which of the first value or the second value is associated with the generated data; means for selecting a first preamble from the selected first subset or the second subset, wherein the resource request comprises an indication of the first preamble; means for obtaining, after output of the resource request, an indication of at least one of: (i) a second set of one or more resources, or (ii) an apparatus-specific identifier configured to identify the apparatus; means for outputting, for transmission via the second set of one or more resources, the generated data and the apparatus-specific identifier; means for obtaining, via a downlink control information (DCI) message, an acknowledgement (ACK) or negative ACK (NACK) associated with the output of the generated data; and means for scrambling cyclic redundancy check (CRC) bits of the DCI based on the apparatus-specific identifier.

The aforementioned means may be one or more of the aforementioned components of the apparatus 1402 configured to perform the functions recited by the aforementioned means. As described supra, the apparatus 1402 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for selecting, means for establishing, means for generating, and means for scrambling may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

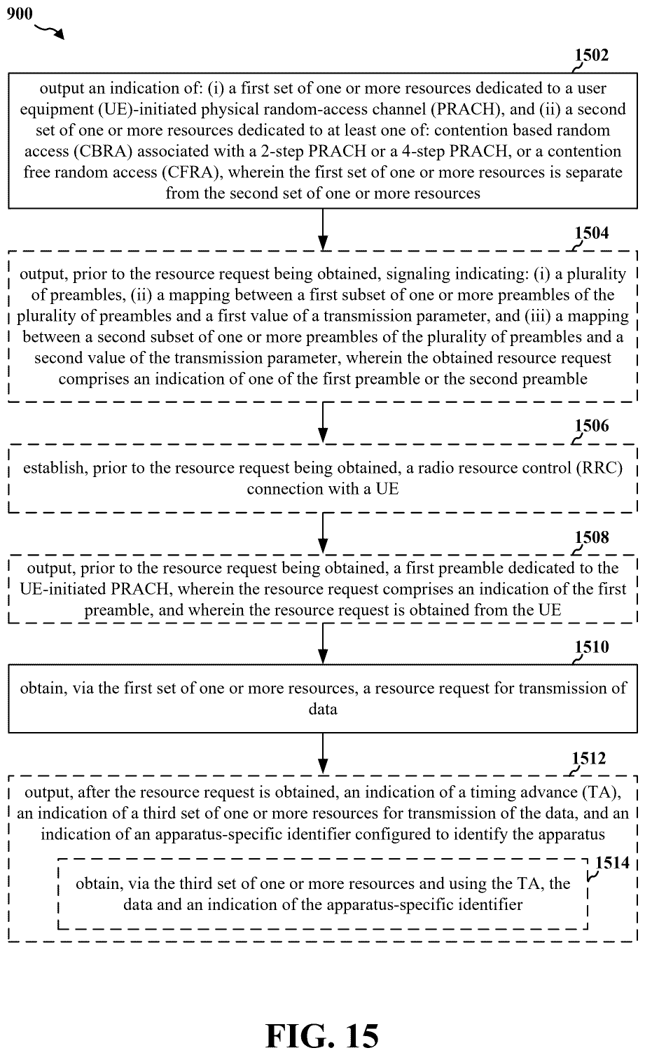

FIG. 15 is a flowchart illustrating a method 1500 of wireless communication. The method may be performed by a network entity (e.g., the base station 102/180; the apparatus 1602. Specifically, the method may be performed by one or more memories, processors, and RF front ends (e.g., the memory 376, controller/processor 375, transmitter 318TX, receiver 318RX, antenna 320, etc. of FIG. 3).

At 1502, the network entity may output an indication of: (i) a first set of one or more resources dedicated to a user equipment (UE)-initiated physical random-access channel (PRACH), and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources. For example, 1502 may be performed by the outputting component 1640. Here, the network entity my provide the UE with an indication of resources dedicated to different random-access procedures. For example, a first set of resources may be dedicated to a UE-initiated PRACH process (e.g., the UE-initiated PRACH process 716 of FIG. 7). Other sets of resources that do not overlap with the first set of resources may be dedicated to other random-access procedures, such as CBRA and CFRA.

At 1504, the network entity may optionally output, prior to the resource request being obtained, signaling indicating: (i) a plurality of preambles, (ii) a mapping between a first subset of one or more preambles of the plurality of preambles and a first value of a transmission parameter, and (iii) a mapping between a second subset of one or more preambles of the plurality of preambles and a second value of the transmission parameter, wherein the obtained resource request comprises an indication of one of the first preamble or the second preamble. For example, 1504 may be performed by the outputting component 1640.

At 1506, the network entity may optionally establish, prior to the resource request being obtained, a radio resource control (RRC) connection with a UE. For example, 1506 may be performed by the establishing component 1642.

At 1508, the network entity may optionally output, prior to the resource request being obtained, a first preamble dedicated to the UE-initiated PRACH, wherein the resource request comprises an indication of the first preamble, and wherein the resource request is obtained from the UE. For example, 1508 may be performed by the outputting component 1640.

At 1510, the network entity may obtain, via the first set of one or more resources, a resource request for transmission of data. For example, 1510 may be performed by the obtaining component 1644.

At 1512, the network entity may optionally output, after the resource request is obtained, an indication of a timing advance (TA), an indication of a third set of one or more resources for transmission of the data, and an indication of an apparatus-specific identifier configured to identify the apparatus. For example, 1512 may be performed by the outputting component 1640.

At 1514, the network entity may optionally obtain, via the third set of one or more resources and using the TA, the data and an indication of the apparatus-specific identifier. For example, 1514 may be performed by the obtaining component 1640.

In certain aspects, the indication of the third set of one or more resources comprises one or more of: a resource block allocation, a modulation and coding scheme (MCS), a quantity of layers, and a precoder.

In certain aspects, the apparatus-specific identifier is obtained via a control channel associated with the second set of one or more resources or a shared channel associated with the third set of one or more resources.

In certain aspects, the resource request is obtained from a UE independent of a radio resource control (RRC) connection being established between the apparatus and the UE.

In certain aspects, the first preamble is a UE-specific preamble.

In certain aspects, each of the plurality of preambles is dedicated to the UE-initiated PRACH.

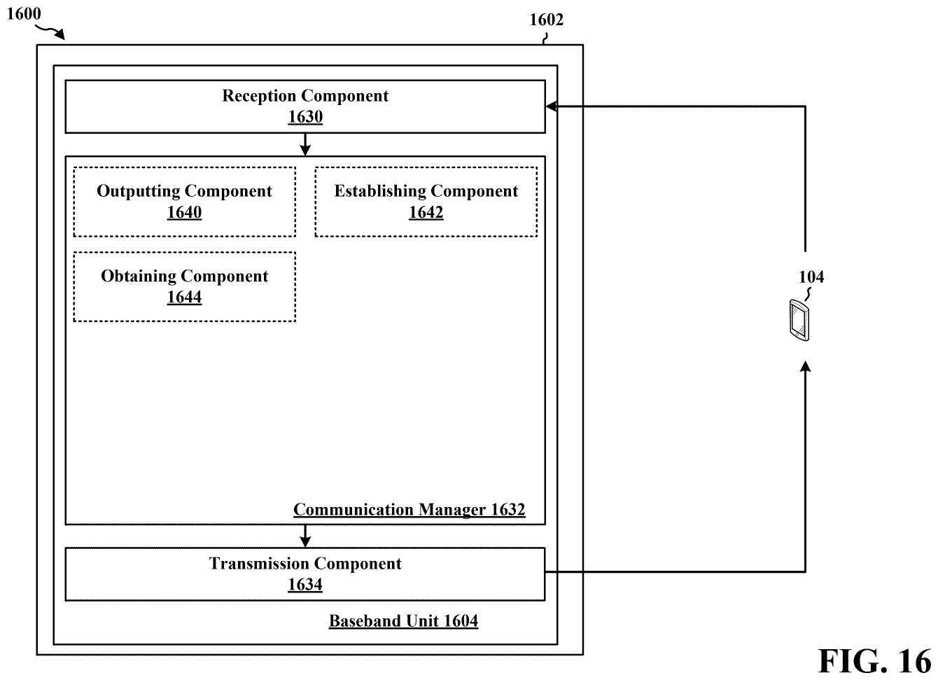

FIG. 16 is a diagram 1600 illustrating an example of a hardware implementation for an apparatus 1602. The apparatus 1602 is a BS and includes a baseband unit 1604. The baseband unit 1604 may communicate through one or more cellular RF transceivers with the UE 104. The baseband unit 1604 may include a computer-readable medium/memory. The baseband unit 1604 is responsible for general processing, including the execution of software stored on the computer-readable medium/memory. The software, when executed by the baseband unit 1604, causes the baseband unit 1604 to perform the various functions described supra. The computer-readable medium/memory may also be used for storing data that is manipulated by the baseband unit 1604 when executing software. The baseband unit 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the baseband unit 1604. The baseband unit 1604 may be a component of the BS 102/180 and may include the memory 376 and/or at least one of the TX processor 316, the RX processor 370, and the controller/processor 375. In various examples, the apparatus 1602 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1632 includes an outputting component 1640 configured to: output an indication of: (i) a first set of one or more resources dedicated to a user equipment (UE)-initiated physical random-access channel (PRACH), and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources; output, prior to the resource request being obtained, signaling indicating: (i) a plurality of preambles, (ii) a mapping between a first subset of one or more preambles of the plurality of preambles and a first value of a transmission parameter, and (iii) a mapping between a second subset of one or more preambles of the plurality of preambles and a second value of the transmission parameter, wherein the obtained resource request comprises an indication of one of the first preamble or the second preamble; output, prior to the resource request being obtained, a first preamble dedicated to the UE-initiated PRACH, wherein the resource request comprises an indication of the first preamble, and wherein the resource request is obtained from the UE; and output, after the resource request is obtained, an indication of a timing advance (TA), an indication of a third set of one or more resources for transmission of the data, and an indication of an apparatus-specific identifier configured to identify the apparatus; e.g., as described in connection with 1502, 1504, 1508, and 1512.

The communication manager 1632 further includes an establishing component 1642 configured to establish, prior to the resource request being obtained, a radio resource control (RRC) connection with a UE, e.g., as described in connection with 1506.

The communication manager 1632 further includes an obtaining component 1644 configured to: obtain, via the first set of one or more resources, a resource request for transmission of data; and obtain, via the third set of one or more resources and using the TA, the data and an indication of the apparatus-specific identifier; e.g., as described in connection with 1510 and 1514.

The apparatus may include additional components that perform each of the blocks of the algorithm in the aforementioned flowchart of FIG. 15. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the baseband unit 1604, includes: means for outputting an indication of: (i) a first set of one or more resources dedicated to a user equipment (UE)-initiated physical random-access channel (PRACH), and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources; means for outputting, prior to the resource request being obtained, signaling indicating: (i) a plurality of preambles, (ii) a mapping between a first subset of one or more preambles of the plurality of preambles and a first value of a transmission parameter, and (iii) a mapping between a second subset of one or more preambles of the plurality of preambles and a second value of the transmission parameter, wherein the obtained resource request comprises an indication of one of the first preamble or the second preamble; means for establishing, prior to the resource request being obtained, a radio resource control (RRC) connection with a UE; means for obtaining, via the first set of one or more resources, a resource request for transmission of data; means for outputting, after the resource request is obtained, an indication of a timing advance (TA), an indication of a third set of one or more resources for transmission of the data, and an indication of an apparatus-specific identifier configured to identify the apparatus; and means for obtain, via the third set of one or more resources and using the TA, the data and an indication of the apparatus-specific identifier.

The aforementioned means may be one or more of the aforementioned components of the apparatus 1602 configured to perform the functions recited by the aforementioned means. As described supra, the apparatus 1602 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver, such as the receive processor 370 and/or antenna(s) 320 of the network entity 102/180 illustrated in FIG. 3. Means for transmitting or means for outputting may include a transmitter such as the transmit processor 316 or antenna(s) 320 of the network entity 102/180 illustrated in FIG. 3. Means for establishing, means for determining, and means for generating may include a processing system, which may include one or more processors, such as the controller/processor 375, the memory 376, and/or any other suitable hardware components of the network entity 102/180 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, the term “establishing” may encompass a wide variety of actions. For example, “establishing” may include calculating, computing, processing, looking up (e.g., looking up in a table, a database or another data structure), and the like.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B,

A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at a wireless node, comprising: generating data for transmission; and outputting, via a first set of one or more resources dedicated to a wireless node-initiated physical random-access channel (PRACH), a resource request for transmission of the generated data.

Example 2 is the method of Example 1, further comprising: obtaining, after output of the resource request, an indication of a timing advance (TA), an indication of a second set of one or more resources for transmission of the generated data, and an indication of an wireless node-specific identifier configured to identify the wireless node; and outputting, for transmission using the TA and the second set of one or more resources, the generated data and the wireless node-specific identifier.

Example 3 is the method of Example 2, wherein the indication of the second set of one or more resources comprises one or more of: a resource block allocation, a modulation and coding scheme (MCS), a quantity of layers, and a precoder.

Example 4 is the method of any of Examples 2 and 3, wherein the wireless node-specific identifier is obtained via a control channel associated with the second set of one or more resources or a shared channel associated with the second set of one or more resources.

Example 5 is the method of any of Examples 1-4, further comprising: obtaining, prior to output of the resource request, an indication of: (i) the first set of one or more resources, and (ii) a second set of one or more resources dedicated to at least one of: a contention based random access (CBRA) associated with a 2-step PRACH or a 4-step PRACH, or a contention free random access (CFRA), wherein the first set of one or more resources is separate from the second set of one or more resources.

Example 6 is the method of Example 5, further comprising: obtaining, prior to output of the resource request, an indication of at least one of: (i) a first preamble dedicated to the wireless node-initiated PRACH, or (ii) a second preamble dedicated to at least one of the CBRA or the CFRA, wherein the resource request includes an indication of the first preamble.

Example 7 is the method of Example 6, further comprising: selecting the first preamble randomly from a plurality of preambles, wherein: the indication of the first set of one or more resources and the indication of the first preamble are obtained via a broadcast message; and the first preamble is one of the plurality of preambles dedicated to the wireless node-initiated PRACH and obtained via the broadcast message.

Example 8 is the method of any of Examples 1-7, wherein the resource request is output for transmission to a network entity independent of a radio resource control (RRC) connection between the wireless node and the network entity.

Example 9 is the method of any of Examples 1-8, further comprising: establishing, prior to output of the resource request, a radio resource control (RRC) connection with a network entity; and obtaining, prior to output of the resource request, a first preamble dedicated to the wireless node-initiated PRACH, wherein the resource request comprises an indication of the first preamble, and wherein the resource request is output for transmission to the network entity.

Example 10 is the method of Example 9, wherein the first preamble is a wireless node-specific preamble.

Example 11 is the method of any of Examples 1-10, further comprising: obtaining, after output of the resource request, a message indicating transmission of a grant; obtaining, via a control channel, the grant, wherein the grant comprises an indication of a timing advance (TA), an indication of a second set of one or more resources, and an indication of an wireless node-specific identifier configured to identify the wireless node; and outputting, for transmission using the TA and the second set of one or more resources, the generated data and the wireless node-specific identifier.

Example 12 is the method of any of Examples 1-11, further comprising: obtaining, prior to output of the resource request, signaling indicating: (i) a plurality of preambles, (ii) a mapping between a first subset of one or more preambles of the plurality of preambles and a first value of a transmission parameter, and (iii) a mapping between a second subset of one or more preambles of the plurality of preambles and a second value of the transmission parameter; selecting one of the first subset or the second subset based on which of the first value or the second value is associated with the generated data; and selecting a first preamble from the selected first subset or the second subset, wherein the resource request comprises an indication of the first preamble.

Example 13 is the method of Example 12, wherein each of the plurality of preambles is dedicated to the wireless node-initiated PRACH.

Example 14 is the method of any of Examples 12 and 13, wherein the transmission parameter comprises at least one of: (i) a range of resources to be used for transmission of the generated data, (ii) a modulation and coding scheme (MCS) to be used for transmission of the generated data, or (iii) a quantity of layers to be used for transmission of the generated data.

Example 15 is the method of any of Examples 12-14, wherein the first preamble is selected randomly.

Example 16 is the method of any of Examples 12-15, wherein the signaling is obtained via one or more of a master information block (MIB) and a system information block (SIB).

Example 17 is the method of any of Examples 1-16, further comprising: obtaining, after output of the resource request, an indication of at least one of: (i) a second set of one or more resources, or (ii) an wireless node-specific identifier configured to identify the wireless node; outputting, for transmission via the second set of one or more resources, the generated data and the wireless node-specific identifier; and obtaining, via a downlink control information (DCI) message, an acknowledgement (ACK) or negative ACK (NACK) associated with the output of the generated data.

Example 18 is the method of Example 17, further comprising: scrambling cyclic redundancy check (CRC) bits of the DCI based on the wireless node-specific identifier.

Example 19 is the method of any of Examples 17 and 18, wherein the ACK is obtained via the DCI, and wherein the DCI comprises one or more bits of the generated data.

Example 20 is the method of any of Examples 17-19, wherein the NACK is obtained via the DCI, wherein the DCI comprises a resource allocation for retransmission of the generated data.

Example 21 is a method for wireless communication at a wireless node, comprising: outputting an indication of: (i) a first set of one or more resources dedicated to a user equipment (UE)-initiated physical random-access channel (PRACH), and (ii) a second set of one or more resources dedicated to at least one of: contention based random access (CBRA) associated with a 2-step PRACH or a 4-step PRACH, or a contention free random access (CFRA), wherein the first set of one or more resources is separate from the second set of one or more resources; and obtaining, via the first set of one or more resources, a resource request for transmission of data.

Example 22 is the method of Example 21, further comprising: outputting, after the resource request is obtained, an indication of a timing advance (TA), an indication of a third set of one or more resources for transmission of the data, and an indication of a wireless node-specific identifier configured to identify the wireless node; and obtaining, via the third set of one or more resources and using the TA, the data and an indication of the wireless node-specific identifier.

Example 23 is the method of Example 22, wherein the indication of the third set of one or more resources comprises one or more of: a resource block allocation, a modulation and coding scheme (MCS), a quantity of layers, and a precoder.

Example 24 is the method of any of Examples 22 and 23, wherein the wireless node- specific identifier is obtained via a control channel associated with the second set of one or more resources or a shared channel associated with the third set of one or more resources.

Example 25 is the method of any of Examples 21-24, wherein the resource request is obtained from a UE independent of a radio resource control (RRC) connection between the wireless node and the UE.

Example 26 is the method of any of Examples 21-25, further comprising: establishing, prior to the resource request being obtained, a radio resource control (RRC) connection with a UE; and outputting, prior to the resource request being obtained, a first preamble dedicated to the UE-initiated PRACH, wherein the resource request comprises an indication of the first preamble, and wherein the resource request is obtained from the UE.

Example 27 is the method of Example 26, wherein the first preamble is a UE-specific preamble.

Example 28 is the method of any of Examples 21-27, further comprising: outputting, prior to the resource request being obtained, signaling indicating: (i) a plurality of preambles, (ii) a mapping between a first subset of one or more preambles of the plurality of preambles and a first value of a transmission parameter, and (iii) a mapping between a second subset of one or more preambles of the plurality of preambles and a second value of the transmission parameter, wherein the obtained resource request comprises an indication of one of the first preamble or the second preamble.

Example 29 is the method of Example 28, wherein each of the plurality of preambles is dedicated to the UE-initiated PRACH.

Example 30 is an apparatus for wireless communications, comprising means for performing a method in accordance with any one of examples 1-20.

Example 31 is an apparatus for wireless communications, comprising means for performing a method in accordance with any one of examples 21-29.

Example 32 is a non-transitory computer-readable medium comprising instructions that, when executed by a wireless node, cause the wireless node to perform a method in accordance with any one of examples 1-20.

Example 33 is a non-transitory computer-readable medium comprising instructions that, when executed by a wireless node, cause the wireless node to perform a method in accordance with any one of examples 21-29.

Example 34 is an apparatus for wireless communications, comprising: one or more memories, individually or in combination, having instructions; and one or more processors, individually or in combination, configured to execute the instructions and cause the apparatus to perform a method in accordance with any one of examples 1-20.

Example 35 is an apparatus for wireless communications, comprising: one or more memories, individually or in combination, having instructions; and one or more processors, individually or in combination, configured to execute the instructions and cause the apparatus to perform a method in accordance with any one of examples 21-29.

Example 36 is a wireless node, comprising: a transceiver; one or more memories, individually or in combination, having instructions; and one or more processors, individually or in combination, configured to execute the instructions and cause the wireless node to perform a method in accordance with any one of examples 1-20, wherein the transceiver is configured to: transmit the resource request.

Example 37 is a wireless node, comprising: a transceiver; one or more memories, individually or in combination, having instructions; and one or more processors, individually or in combination, configured to execute the instructions and cause the wireless node to perform a method in accordance with any one of examples 21-29, wherein the transceiver is configured to: transmit the indication of the first set of one or more resources and the second set of one or more resources; and receive the resource request.

What is claimed is:

1. An apparatus for wireless communication, comprising:
one or more memories, individually or in combination, having instructions; and
one or more processors, individually or in combination, configured to execute the instructions and cause the apparatus to:
generate data for transmission; and
output, via a first set of one or more resources dedicated to an apparatus-initiated physical random-access channel (PRACH), a resource request for transmission of the generated data.

2. The apparatus of claim 1, wherein the one or more processors, individually or in combination, are further configured to cause the apparatus to:
obtain, after output of the resource request, an indication of a timing advance (TA), an indication of a second set of one or more resources for transmission of the generated data, and an indication of an apparatus-specific identifier configured to identify the apparatus; and
output, for transmission using the TA and the second set of one or more resources, the generated data and the apparatus-specific identifier.

3. The apparatus of claim 2, wherein the indication of the second set of one or more resources comprises one or more of: a resource block allocation, a modulation and coding scheme (MCS), a quantity of layers, and a precoder.

4. The apparatus of claim 2, wherein the apparatus-specific identifier is obtained via a control channel associated with the second set of one or more resources or a shared channel associated with the second set of one or more resources.

5. The apparatus of claim 1, wherein the one or more processors, individually or in combination, are further configured to cause the apparatus to:
obtain, prior to output of the resource request, an indication of: (i) the first set of one or more resources, and (ii) a second set of one or more resources dedicated to at least one of:
contention based random access (CBRA) associated with a 2-step PRACH or a 4-step PRACH, or
a contention free random access (CFRA),
wherein the first set of one or more resources is separate from the second set of one or more resources.

6. The apparatus of claim 5, wherein the one or more processors, individually or in combination, are further configured to cause the apparatus to:
obtain, prior to output of the resource request, an indication of at least one of: (i) a first preamble dedicated to the apparatus-initiated PRACH, or (ii) a second preamble dedicated to at least one of the CBRA or the CFRA, wherein the resource request includes an indication of the first preamble.

7. The apparatus of claim 6, wherein the one or more processors, individually or in combination, are further configured to cause the apparatus to:
select the first preamble randomly from a plurality of preambles, wherein:
the indication of the first set of one or more resources and the indication of the first preamble are obtained via a broadcast message; and
the first preamble is one of the plurality of preambles dedicated to the apparatus-initiated PRACH and obtained via the broadcast message.

8. The apparatus of claim 1, wherein the resource request is output for transmission to a network entity independent of a radio resource control (RRC) connection between the apparatus and the network entity.

9. The apparatus of claim 1, wherein the one or more processors, individually or in combination, are further configured to cause the apparatus to:
establish, prior to output of the resource request, a radio resource control (RRC) connection with a network entity; and
obtain, prior to output of the resource request, a first preamble dedicated to the apparatus-initiated PRACH, wherein the resource request comprises an indication of the first preamble, and wherein the resource request is output for transmission to the network entity.

10. The apparatus of claim 9, wherein the first preamble is an apparatus-specific preamble.

11. The apparatus of claim 1, wherein the one or more processors, individually or in combination, are further configured to cause the apparatus to:
obtain, after output of the resource request, a message indicating transmission of a grant;
obtain, via a control channel, the grant, wherein the grant comprises an indication of a timing advance (TA), an indication of a second set of one or more resources, and an indication of an apparatus-specific identifier configured to identify the apparatus; and
output, for transmission using the TA and the second set of one or more resources, the generated data and the apparatus-specific identifier.

12. The apparatus of claim 1, wherein the one or more processors, individually or in combination, are further configured to cause the apparatus to:
obtain, prior to output of the resource request, signaling indicating: (i) a plurality of preambles, (ii) a mapping between a first subset of one or more preambles of the plurality of preambles and a first value of a transmission parameter, and (iii) a mapping between a second subset of one or more preambles of the plurality of preambles and a second value of the transmission parameter;
select one of the first subset or the second subset based on which of the first value or the second value is associated with the generated data; and
select a first preamble from the selected first subset or the second subset, wherein the resource request comprises an indication of the first preamble.

13. The apparatus of claim 12, wherein each of the plurality of preambles is dedicated to the apparatus-initiated PRACH.

14. The apparatus of claim 12, wherein the transmission parameter comprises at least one of: (i) a range of resources to be used for transmission of the generated data, (ii) a modulation and coding scheme (MCS) to be used for transmission of the generated data, or (iii) a quantity of layers to be used for transmission of the generated data.

15. The apparatus of claim 12, wherein at least one of:
the first preamble is selected randomly, or
the signaling is obtained via one or more of a master information block (MIB) and a system information block (SIB).

16. The apparatus of claim 1, wherein the one or more processors, individually or in combination, are further configured to cause the apparatus to:
obtain, after output of the resource request, an indication of at least one of: (i) a second set of one or more resources, or (ii) an apparatus-specific identifier configured to identify the apparatus;
output, for transmission via the second set of one or more resources, the generated data and the apparatus-specific identifier; and
obtain, via a downlink control information (DCI) message, an acknowledgement (ACK) or negative ACK (NACK) associated with the output of the generated data.

17. The apparatus of claim 16, wherein the one or more processors, individually or in combination, are further configured to cause the apparatus to:
scramble cyclic redundancy check (CRC) bits of the DCI based on the apparatus-specific identifier.

18. The apparatus of claim 16, wherein the ACK is obtained via the DCI, and wherein the DCI comprises one or more bits of the generated data.

19. The apparatus of claim 16, wherein the NACK is obtained via the DCI, wherein the DCI comprises a resource allocation for retransmission of the generated data.

20. The apparatus of claim 1, further comprising a transceiver configured to:
transmit the resource request for transmission of the generated data, wherein the apparatus is configured as a user equipment (UE).

21. An apparatus for wireless communication, comprising:
one or more memories, individually or in combination, having instructions; and
one or more processors, individually or in combination, configured to execute the instructions and cause the apparatus to:
output an indication of: (i) a first set of one or more resources dedicated to a user equipment (UE)-initiated physical random-access channel (PRACH), and (ii) a second set of one or more resources dedicated to at least one of:
contention based random access (CBRA) associated with a 2-step PRACH or a 4-step PRACH, or
a contention free random access (CFRA),
wherein the first set of one or more resources is separate from the second set of one or more resources; and
obtain, via the first set of one or more resources, a resource request for transmission of data.

22. The apparatus of claim 21, wherein the one or more processors, individually or in combination, are further configured to cause the apparatus to:
output, after the resource request is obtained, an indication of a timing advance (TA), an indication of a third set of one or more resources for transmission of the data, and an indication of an apparatus-specific identifier configured to identify the apparatus; and
obtain, via the third set of one or more resources and using the TA, the data and an indication of the apparatus-specific identifier.

23. The apparatus of claim 22, wherein the indication of the third set of one or more resources comprises one or more of: a resource block allocation, a modulation and coding scheme (MCS), a quantity of layers, and a precoder.

24. The apparatus of claim 22, wherein the apparatus-specific identifier is obtained via a control channel associated with the second set of one or more resources or a shared channel associated with the third set of one or more resources.

25. The apparatus of claim 21, wherein the resource request is obtained from a UE independent of a radio resource control (RRC) connection being established between the apparatus and the UE.

26. The apparatus of claim 21, wherein the one or more processors, individually or in combination, are further configured to cause the apparatus to:
establish, prior to the resource request being obtained, a radio resource control (RRC) connection with a UE; and
output, prior to the resource request being obtained, a first preamble dedicated to the UE-initiated PRACH, wherein the resource request comprises an indication of the first preamble, and wherein the resource request is obtained from the UE.

27. The apparatus of claim 21, wherein the one or more processors, individually or in combination, are further configured to cause the apparatus to:
output, prior to the resource request being obtained, signaling indicating: (i) a plurality of preambles, (ii) a mapping between a first subset of one or more preambles of the plurality of preambles and a first value of a transmission parameter, and (iii) a mapping between a second subset of one or more preambles of the plurality of preambles and a second value of the transmission parameter, wherein the obtained resource request comprises an indication of one of the first preamble or the second preamble.

28. The apparatus of claim 27, wherein each of the plurality of preambles is dedicated to the UE-initiated PRACH.

29. The apparatus of claim 21, further comprising a transceiver configured to:
transmit the indication of: (i) the first set of one or more resources, and (ii) the second set of one or more resources; and
receive the resource request for transmission of data, wherein the apparatus is configured as a network entity.

30. A method for wireless communication at a wireless node, comprising:
generating data for transmission; and
outputting, via a first set of one or more resources dedicated to a wireless node-initiated physical random-access channel (PRACH), a resource request for transmission of the generated data.
